(19) United States
(12) Patent Application Publication
(10) Pub. No.: US 2018/0357644 A1
(43) Pub. Date: Dec. 13, 2018

(54) BIOMETRIC CARD WITH BIOMETRIC AUTHENTICATION SENSOR

(71) Applicant: JOSEPH A. TABE, Silver Spring, MD (US)

(72) Inventor: JOSEPH A. TABE, Silver Spring, MD (US)

(21) Appl. No.: 15/619,521

(22) Filed: Jun. 11, 2017

(51) Int. Cl. G06Q 20/40; G06K 9/00

(52) U.S. Cl. CPC G06Q 20/40145; G06K 9/00892; G06K 9/00087

(57) ABSTRACT

A biometric card includes sensors embedded in nanofiber substrate for detecting biometric contents. The sensor are configured for analyzing biological characteristics such as human characteristics for security and identification purposes. Embodiments provide means for identifying biological characteristics to detect from a database of fingerprints, a known criminal by matching fingerprint samples collected with prints in the criminal database. Embodiments provide a sweep-able biometric card embedded with biometric authentication sensor associated with biometric authentication sensing surface disposed in a reachable low-stress region. The reachable low-stress region has a dimension substantially smaller than the biometric card for biometric detections and applications for DNA fingerprinting. Embodiments provide a system for verifying and tracking identification information and for delivering security solutions that includes one of the following: a radio frequency (RF) identification device, an identification mechanism that includes a person, wearables, card, sticker, DNA fingerprinting and programmed phone number, and an RF reader.

This Application claims priority benefits from application Ser. No. 13/328,383 filed on Dec. 16, 2011.

### FIELD OF THE INVENTION

The invention relates to a biometric card with embedded biometric authentication sensor, and more particularly to a biometric card with a sweep-able and pressure point biometric authentication sensor. The present invention generally relates to a system and method for providing secure credit card identification solutions, data security, internet security, data transport layer security, computer security, and specifically to a system and method for verifying and tracking identification information of personal identification card users. The biometric card is a unique, measurable, biological characteristic or trait awareness card for automatically recognizing or verifying the identity of a person who is using the card. Disclosed embodiments provide a biometric card for analyzing biological characteristics that includes the science of biometrics typically used for analyzing human characteristics involving credit card, computer security, passport security, electronic security, and other applications for security purposes.

Disclosed embodiments further provide a biometric card comprising portable apparatus for measuring biological characteristics influential to trait recognition and/or fraud. Certain embodiment provides the biometric card further configured for verifying the identity of a human being. Some embodiments provide the biometric card further configured for analyzing biological characteristics such as human characteristics for security and identification purposes, including at least fingerprint, hand, eye, face, and voice. Other embodiments provide the biometric card further comprises means for identifying biological characteristics to detect from a database of fingerprints, a known criminal by matching fingerprint samples collected against the prints in the criminal database.

### BACKGROUND OF THE INVENTION

The invention relates to a biometric card in association with a database of collected DNA samples having accurate and distinctive fingerprint classification schemes or pattern that is required for expediting fingerprinting processes. Disclosed embodiments further provide the biometric card configured for communication with a database for reducing the required database search to identify characteristics of the hand, finger, face, voice, ear shape, DNA, body odor, or eye. The identification process of the biometric card further includes biometric identification and authentication. Disclosed embodiments provide the biometric card being disposed to eliminate trait by enabling biometric identification as a process of matching an individual to a set of biometric characteristics within a system such as the database. The database is configured with software instructions that includes rules for enabling biometric authentication. Certain embodiment provides the rules include a one-to-one match for verifying that the individual who presents the biometric card is who he claims to be or the person entering the building or accessing an electronic system such as the logon to a computer system is who he says he is by identifying the sweat pore location.

The Biometric card identification would include two stages: enrollment and verification. Whereby during the enrollment stage, a sample of the designated person's biometric is acquired, and whereby some unique characteristics or features of this sample are extracted to form a biometric template for future comparison purposes, and wherein during the verification stage, an updated biometric sample is acquired. In all, features of this biometric sample are extracted. These features are then compared with the previously generated biometric template. Disclosed embodiments provide a biometric card disposed with varieties of solutions for making secure and durable identifications that are resistant to fraud and counterfeiting.

The invention is provided to prevent a syndicate from counterfeiting the identification cards such as credit cards, personal identification cards, driver's licenses, passports, employee identification cards, social welfare cards and health insurance cards, device authentication, bank money bands, current card issuer have to spend a lot of resource to protect the identification cards with strict security designs. Since the biometric authentication is the personal biometric data and cannot be counterfeited, the identification card is embedded with the biometric authentication sensor to advance security and to prevent theft by developing the biometric card as the mainstream development in the future card processing applications for personal authentication, data security, internet security, and data transport layer security.

All the biometric authentication sensors embedded in nanofiber substrate. The substrate includes cantilever substrate, silicon substrate, thin film substrate, piezoelectric substrate, CMOS substrate, Field Propagation Gate Array “FPGA” substrate, MEMS substrate, plasmonic substrate, photonic substrate, electrochromic substrate, multiple antennas on-chip substrate, carbon nanotube substrate, each associated with the detection analysis, signal detection analysis, and network applications. That is, the biometric authentication sensor can acquire the biometric fingerprinting and programmed phone number authentication image as long as the finger statistically contacts the biometric authentication sensor region. The identification card is a flexible and bendable portable device to prevent extreme stress, cracks, and fracture. The substrates are configured so that energy can be applied to them, including electromagnetic energy to observe excitation wavelength when the biometric card is processed, and to structure a network for long range and short range communications and data transmission. The short range and long range communication and data transmission further includes millimeter wave network.

It is an important subject of the present invention to provide a biometric card with an identification system that is embedded with a biometric authentication sensor that cannot be easily damaged and that is configured to transmit data to short range and long range network. Embodiments further provide Li-Fi network, Wi-Fi network, and millimeter wave network.

### SUMMARY OF THE INVENTION

The present invention eliminates the insecurity of the cryptographic key and also the passcode system due to practical problems of remembering various passcodes. Additionally, some users tend to choose simple words, phrases, or easily remembered personal data, while others resort to writing the passcode down on an accessible document to avoid data loss. The ongoing passcode methods of security poses potential security risks because the passcode is not tied to a user. That is, the system running the cryptographic algorithm is unable to differentiate between the legitimate user and an attacker who fraudulently acquires the passcode of a legitimate user. Disclosed embodiments provide the biometric card as an alternative to passcode protection because the biometric authentication offers a new mechanism for key security by using a biometric to secure the cryptographic key. That is, instead of entering a passcode to access the Cryptographic key, disclosed embodiments provide the biometric card system so that the use of this key is guarded by biometric authentication. In this endeavor, when a computer user wishes to access a secured key, the software program will prompt him to allow for the capture of a biometric sample. If this verification sample matches the enrollment template, then the key is released and can be used to encrypt or decrypt the desired data. Disclosed embodiments provide the biometric card as a means to offer convenience because the user will no longer need to remember the passcode or to secure identity confirmation because only the valid user can use the biometric card.

It is therefore an object of the invention to provide a low-cost biometric card having a sweep-able and biometric authentication sensor that cannot be easily damaged. The biometric card may be used in numerous embodiments, including, but not limited to: an RF Registration. Item such as License Plate, an RF Identification mechanism for identifying falsification such as credit cards, electronic device cryptography, device authentications, bank money bands, and/or Passport, an RF Communications Device such as Cellular Telephone method of Use. RF boarding communication Device such as airport and border patrol and border crossing applications. RF Transportation Applications such as communications within transportation authority. A software defined RF Communication device such as limiting downloads to authorized users. A System and Method for applying advanced airport security control.

The invention achieves the above-mentioned object by providing a biometric card which includes a nanofiber substrate, microfiber substrate and/or a substrate embedded with sensors. The substrate is fused/etched in nanofiber to provide a sweep-able and fingerprinting authentication system. The authentication system also includes a programmed phone number associated with the biometric authentication sensor region. The sweep-able biometric authentication sensor has an exposed biometric authentication sensing surface, and is disposed in a reachable low-stress region. The reachable low-stress region has a dimension substantially configured for fingerprint authentication in real time application. A reader is configured with the biometric card. The reader includes a server, a computer, an electronic device, a cell phone, a stationary electronic device, or a portable electronic device. The substrate is preferably formed with silicon through which the sweep-able, the fingerprinting, and the programmed phone number biometric authentication sensor is positioned, wherein a groove is provided for guiding the user to put his/her finger therein, and for guiding the finger to sweep across the sweep-able biometric authentication sensor region.

The present invention further provides a method and system for verifying and tracking users and for providing user identification information. In an embodiment of the invention, the reader is a system for delivering security solutions that includes at least one of the following: a radio frequency (RF) identification, global positioning system identification, and a biometric identification mechanism. The biometric identification mechanism includes cards, stickers, driver's license, employee identification card, personal identification cards, driver's licenses, passports, electronic device cryptography, device authentications, bank money bands, social welfare cards, health insurance cards and an RF reader/writer.

The present invention is not limited to the above embodiments. Additional advantages and novel features of the invention will be set forth in part in the Description that follows, and in part will become more apparent to those skilled in the art upon examination of the following or upon learning by practice of the invention. Further embodiments of the present invention are discussed below. Those experienced in the art will see that multiple features of certain embodiments described below can be incorporated into other embodiments both described and not described below.

### BRIEF DESCRIPTION OF THE DRAWINGS

FIG. 1 is an exemplary application of the biometric card in a network environment.

FIG. 2 is an exemplary embodiment of the biometric card illustrating the front side A and the back side B.

FIG. 3 is seen further exemplary embodiment of application of the low stress region of the biometric card.

FIG. 4 is an exemplary embodiment of the biometric card with the biometric authentication sensor in a network.

FIG. 5 is an exemplary embodiment showing the biometric card with the biometric authentication sensor of the invention.

FIG. 6 is an exemplary embodiment of a biometric passport being disposed with sensors and a low stress distribution region.

FIG. 7 is seen further exemplary embodiment of the biometric card in a network.

FIG. 8 shows an exemplary chart of the biometric card that includes passport.

FIG. 9 is seen further exemplary embodiment of the biometric card in a network.

FIG. 10 is seen further exemplary embodiment of the biometric passport according to the embodiment of the invention.

FIG. 11 is seen further exemplary embodiment of the biometric money bands according to the embodiment of the invention.

### DETAILED DESCRIPTION OF THE INVENTION

The invention provides a biometric card having a low pressure point region associated with a biometric sensing surface for DNA fingerprinting and a programmed phone number, in association with a sweep-able biometric authentication sensor is disclosed. The biometric sensing surface and the sweep-able biometric authentication sensor are adapted to the biometric card.

The terminology used herein is for the purpose of describing particular embodiments only and is not intended to be limited to a specific embodiment. As used herein, the singular forms “a”, “an”, “at least”, “each”, “one of”, and “the” are intended to include the plural forms as well, unless the context clearly indicates otherwise. It would be further understood that the terms “include”, “includes” and/or “including”, where used in this specification, specify the presence of stated features, integers, steps, operations, elements, and/or components, but do not preclude the presence or addition of one or more other features, integers, steps, operations, elements, components, and/or groups thereof.

In describing example embodiments as illustrated in the drawings, specific terminology is employed for the sake of clarity. However, the disclosure of this invention is not intended to be limited to the specific terminology so selected and it is to be understood that each specific element includes all technical equivalents that operate and/or function in a similar manner. It would be further noted that some embodiments of the biometric card are used concomitantly and/or not used concomitantly with biometric identification and authentication. This is rather than using the authentication as a means to reflect initial operating processes of identification. In certain embodiments, the biometric card comprises a standard platform for global identification and trait awareness system. In some embodiments, the biometric card is a card that enables biometric authentication as an array and/or a platform responsive to identification, trait, detection, crime, transportation, security, identity, and medical applications. Other embodiments herein describe apparatus configured for ensuring security and for enabling identification via DNA fingerprinting.

The foregoing and/or other objects and advantages would appear from the description to follow. Reference is made to the accompanying drawing, which forms a part hereof, and in which is shown by way of illustration specific embodiments only in which the embodiments may be practiced. These embodiments being described in sufficient details to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims.

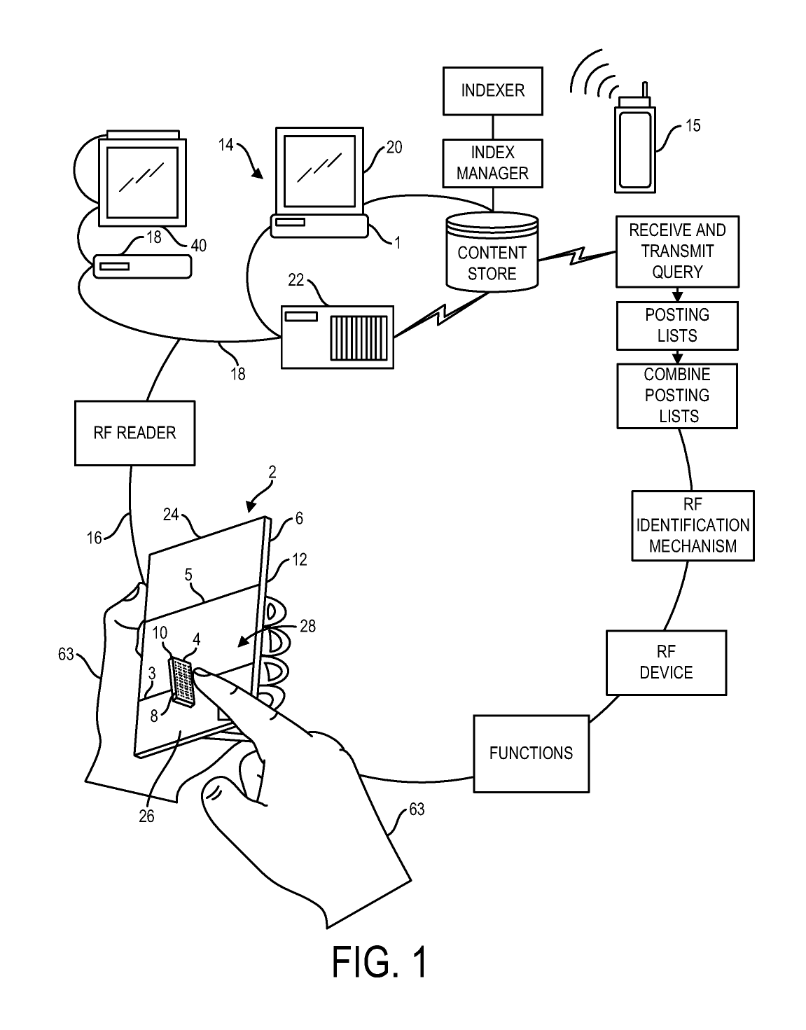

Referring to FIG. 1 is seen an exemplary embodiment of the biometric card 2, being disposed with sensors 1. The sensors 1 are embedded in silicon substrate 3 and etched and/or fused in nanofiber/microfiber material 5 having excellent electrical and conductive properties configured for providing advanced authentication, data security, internet security, and data transport layer security. The biometric card 2 is disposed with stress-strain region 4 of a silicon substrate 6. The biometric card 2, having a biometric sensing surface “BSS” 8, in association with a sweep-able biometric authentication sensor “SEAS” 10. Disclosed embodiments provide the sweep-able biometric authentication sensor 10 adopts a nanofiber material 12. The nanofiber material 12 having excellent electrical characteristics for enabling faster card processing analysis and simulation. Embodiments provide the biometric card 2 further configured for providing excellent cryptographic environment 14 for ensuring secured information exchange across other platforms, including the Internet 16 and/or intranet 18.

Other embodiments provide the biometric card 2, further configured for providing computer security across information exchange environments where standard computer security require computer users to remember and enter their cryptographic keys each time they want to use the computer. Because of the current cryptographic deficiencies, users typically are required to choose an easily remembered passcode that is used to encrypt the cryptographic key. This encrypted key is then stored on a computer's hard drive. To retrieve the cryptographic key, the user is prompted to enter the passcode, which will then be used to decrypt the key. Embodiments provide a computer security 20 using biometric encryption 22 in place of password cryptography. The biometric card 2 is further configured with a sweep-able biometric authentication sensor 10. The biometric card 2 includes silicon substrate 3 configured for communications and network applications. The substrate further comprising at least one of nanofiber substrate, microfiber substrate, piezoelectric substrate, carbon black substrate, load cell substrate, MEMS substrate, NEMS substrate, thin film substrate, cantilever substrate, carbon nanotubes substrate, FPGA substrate, opto-isolator substrate, plasmonic substrate, photonic substrate, electrochromic substrate, zinc substrate, non-ferrous substrate, herein referred to as the substrate 6, which are deployed with embedded sensors 24 and nanofibers 12 having excellent conductive properties. The substrate is configured to provide communication applications, faster data transmission, and better signal and network applications. A biometric authentication sensor “BAS” 26, is embedded into the substrate 6 and has an assigned biometric authentication sensing surface “BASS” 28.

In order to prevent the biometric authentication sensor 26, which is embedded into the substrate 6, from being damaged when the biometric card 2 is bent or twisted, the invention employs the application of nanofiber 12 to enable efficient data transmission and to further maximize stress associated with the physical properties of the substrate 6 and the biometric authentication sensor 26. Certain embodiments provide the biometric authentication sensor 26 of the invention is embedded in the silicon substrate 6 and fused and/or etched in the nanofiber/microfiber material. Biometric data are stored in database associated with content store. The database is to be managed by software in communication with an indexer. The indexer is in communication with an index manager operable to collect user data, including biometric data, and to store each sets of data associated with a user in cells that are identifiable and are accessed by biometric cryptography and/or by a unique identification numbers. The unique identification numbers are software generated to optimize performance, speed, and data security. The content store is in communication with the cells. The index manager manages the indexer to ensure that the indexer returns a value or the reference to a value associated with the queried cell.

The content store is configured to receive and to transmit from the cells, biometric queries and other data associated with the user of the biometric card 2. At least a radio frequency “RF” reader is configured for communication with an RF device provided for receiving functions and for communication with the biometric card. The RF device is further associated with an RF identification mechanism configured to enable posting list or a combined posting list associated with users of the biometric card 2. Certain embodiments provide an electronic communication device 15 configured for communication with the biometric card 2.

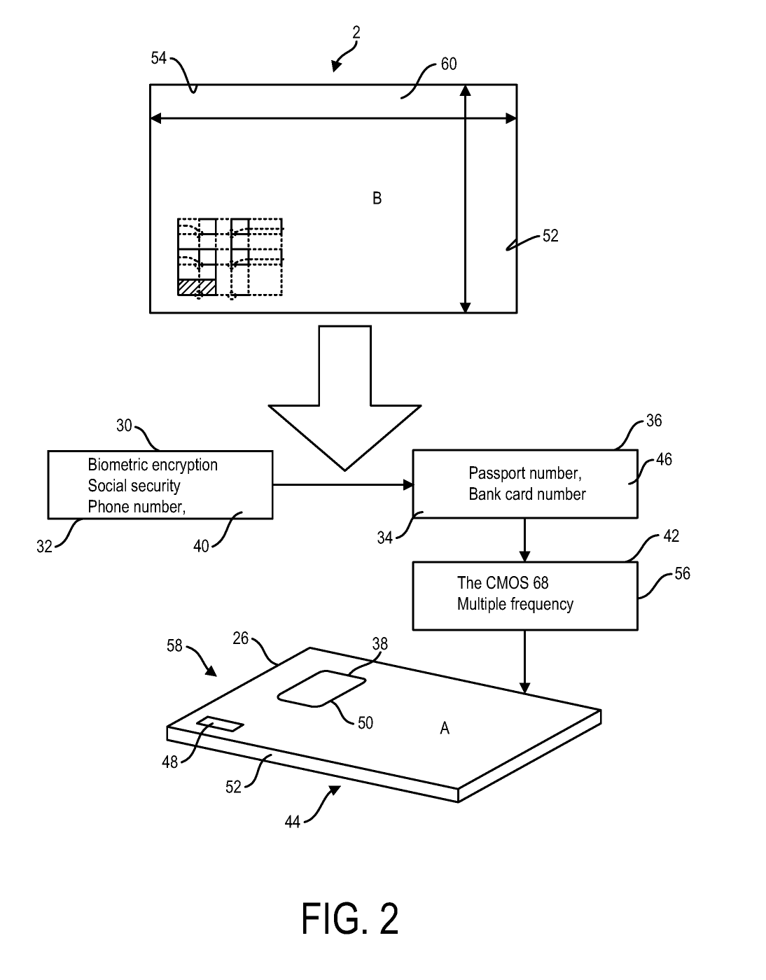

Referring to FIG. 2, the biometric card 2 is provided with two sides “A” and “B.” The first side A, is disposed with the user information 30 that includes at least one of names 32, biometric encryption details, embedded social security data, phone number, card expiration date 34, card number 36, passport number, bank card number, the DNA fingerprinting region 38, and programmed phone number region 40 associated with the biometric authentication sensor 26, for communication with the CMOS multiple antennas on chip 68. The multiple antennas being disposed with multiple frequencies and with good isolation between GPS and Wi-Fi/Li-Fi band. Some embodiments provide the CMOS multiple antennas on chip further comprises on chip miniaturized antennae in association with software.

The card number 36 is further associated with the user's phone number 40, such that when the biometric card 2 is processed without the application of the DNA fingerprinting region 38, and/or the programmed phone number region 40, the biometric authentication sensor 26 would automatically dial the user's phone number 40 that is in record, such as was saved in the memory of biometric card reader “BCR” 42. The user 44 of the biometric card 2 would then use the cell phone 46 or any configured electronic device to identify self. The identification process includes the application of software 48 by using a software defined DNA fingerprinting “SDDNAF” 50 and programmed phone number “PPN” 52 installed on the cell phone 46 for communication with the biometric card 2. The software defined DNA fingerprinting 50 may be operable by an application software 54 or mobile application software 56 “mobile app”. The fingerprint 58 of the user 44 would then be confirmed by the reader 42 or processor such as the bank teller 58 that the user 44 of the biometric card 2 is authentic. The second side B of the biometric card 2 is disposed with a swipe-able region 60. The swipe-able region 60 is also associated with the user 44 or the user's phone 46 to enable proper authenticity.

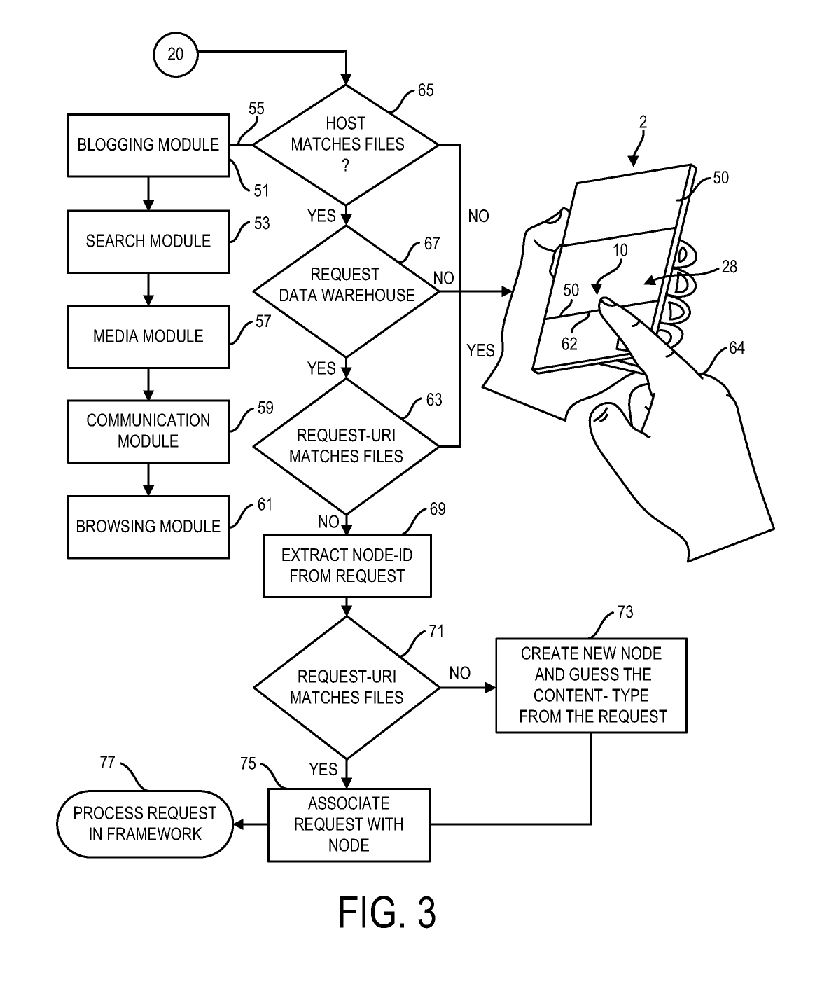

Referring to FIG. 3 is provided further exemplary embodiment of the biometric 2. The biometric card 2 being disposed with a sweep-able biometric authentication sensor 10 affixed in a reachable low-stress region “RLSR” 62. The low-stress region 62 is the region that is governed by safety applications. In this embodiment, the sweep-able biometric authentication sensor 10 is parallel to the biometric authentication sensing surface 28 and configured such that a finger 64 is swipe-able across it to enable the gathering of fingerprint data. The fingerprint data is readable and identifiable with the application of software defined DNA fingerprinting 50 and/or programmed phone number 52. The software defined DNA fingerprinting is further associated with a computer to provide computer security 20. The computer is further configured for biometric hierarchy analysis that includes communications with a blogging module in association with DNA fingerprinting data 51, rules and software instruction module 55, a search module 53, a media module 57, a communication module 59, and a browsing module 61. The computer is further disposed with the computer security 20 and software in association with user files 65, fingerprint data 67, URI history file 63 and 71, node extractor 69, node creator 73, node association 75, and a request processor 77.

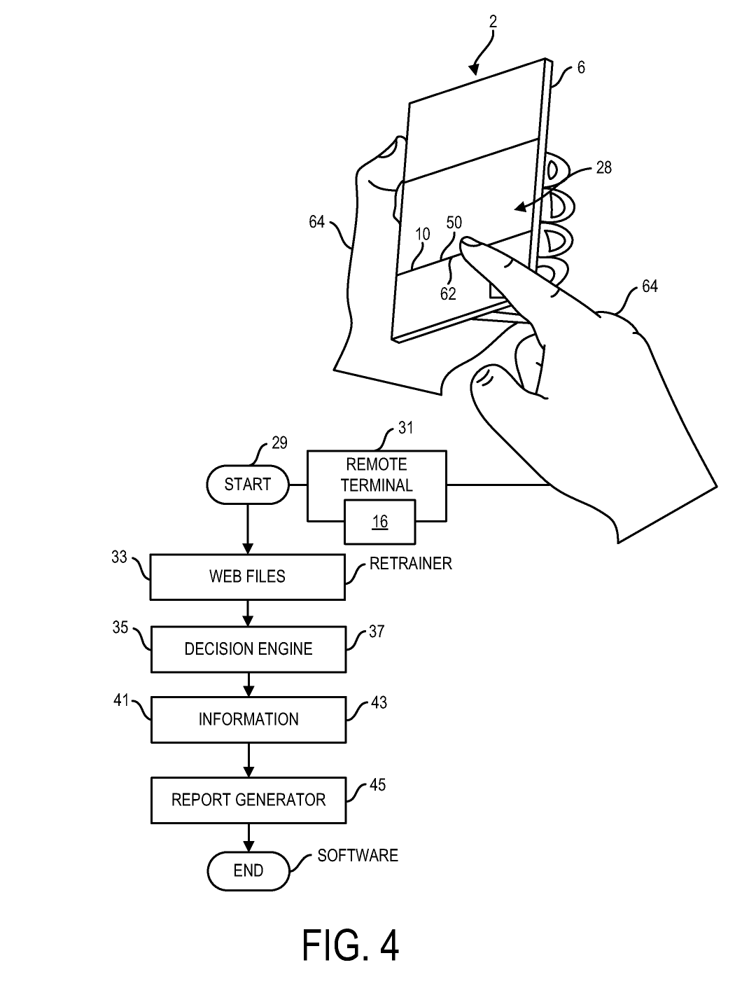

Referring to FIG. 4 is seen further exemplary embodiment of the biometric card 2. The biometric card 2 according to some embodiment of the invention, is configured for communication with a remote terminal 31 to start a remote communication that includes the internet 16. The remote communication further includes accessing web files 33, processing a retainer to retain data, communicating with a decision engine 35, generating data 37, processing information 41, providing requested information 43, reporting queried data 45, via software application The sweep-able biometric authentication sensor 10 is associated with the biometric card 2 and disposed in the reachable low-stress region 62. Other embodiment provide the biometric authentication sensor 10 having an authentication sensing surface 28. The authentication sensing surface 28 is configured such that the finger 64 sweeps across it to provide data associated with the DNA fingerprinting 50. The DNA fingerprinting data 51 is a biometric data associated with the user's programmed phone number 52 and/or images of the person associated with the biometric card 2.

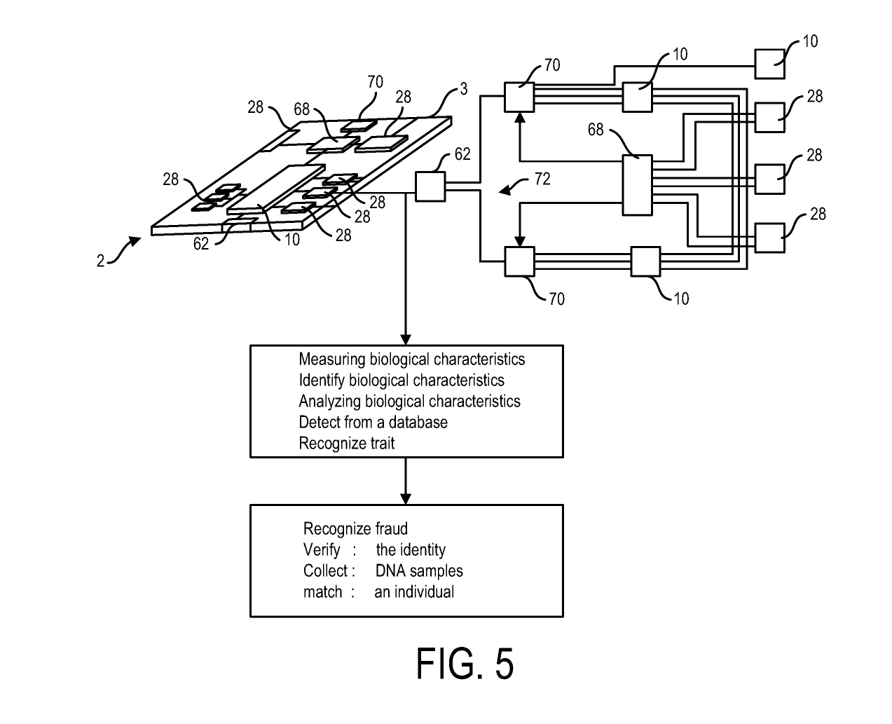

Referring to FIG. 5 is seen a biometric card 2 according to the embodiment of the invention. The biometric card 2 is disposed with the sweep-able biometric authentication sensor 10. The sweep-able biometric authentication sensor 10 is configured for communication at the low-stress region 62. In other disclosure, the biometric authentication sensing surface 28 is an embodiment that the finger may sweep across it in the direction of a fine swipe-able sensor surface “FSSS” 66, wherein the identification information is taken for biometric authentication. In the disclosed embodiments, the picture or image of the holder may be written on the CMOS chip 68 for communication with an RF device 70. The CMOS multiple antennas on-chip 68 is embedded on the substrate 3 to provide the identification and authentication platform 72. The biometric card 2 further configured for electronic device cryptography, device authentications, bank money bands for tracking money destination, including applications for license plate, insurance card, employee's identification card, passport identification and processing, cards bands, driver's license, and credit cards. In other embodiments, a user 44 enters an area where identification information must be presented. The reader/writer 74 is configured to read the identification information from the CMOS multiple antennas on-chip 68 to recognize fraud, to verify the identities collected, and to verify that the DNA samples collected matches that of the individual in question. The chip is further disposed with software configured with programmed instructions for measuring biological characteristics, for identifying biological characteristics, for analyzing biological characteristics, for communication with a database, and for recognizing trait. In other embodiments, all information are compared to the CMOS chip data to verify the user's identity and to provide data security, internet security, and data transport layer security. Embodiments provide the biometric card 2 further comprises substrate nanofiber with nano sensors.

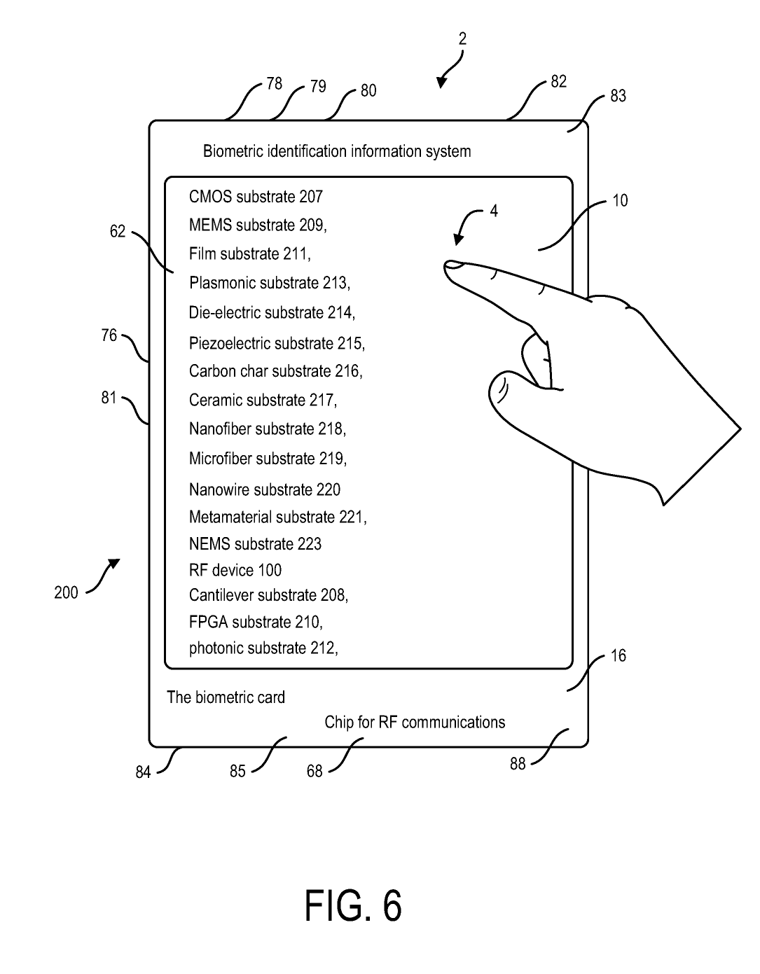

Referring to FIG. 6 is further seen the biometric card 2 according to certain embodiment of the invention. The biometric card further comprises a passport 200 disposed with a sweep-able biometric authentication sensor 10. The sweep-able biometric authentication sensor is embedded in the substrate 6 and etched/fused in nanofiber/microfiber material 12 and disposed in the stress strain region 4 and/or the low-stress region 62. The substrate further includes CMOS substrate 207, MEMS substrate 209, thin film substrate 211, plasmonic substrate 213, die-electric substrate 214, piezoelectric substrate 215, carbon char substrate 216, ceramic substrate 217, nanofiber substrate 218 microfiber substrate 219, nanowire substrate 220, metamaterial substrate 221, cantilever substrate 208, NEMS substrate 223, FPGA substrate 210, and photonic substrate 212.

Disclosed embodiments provide an authorization platform 76 whereby authorities may track information regarding a registered item such as a vehicle 78 to identify the item, and to determine whether the driver/user information 30 corresponds to the right to operate the vehicle through the information on the license plate 79. In the case of the vehicle 78, a sticker 80 or decal 81 can be placed on the automobile window 82, windshield 83, bumper 84, or anywhere within the vehicle “Placement Media 85” for communications with local and state authorities when the vehicle 78 is stolen. In this case, the chip 68 may be embedded directly into the license plate 79 and the cell phone may be configured for use to activate the chip 68 and enable communications with all authorities via internet 16 and other forms of communication for tracking the vehicle 78 when stolen. The chip 68 is further disposed with a GPS device 88 for tracking stolen or crime vehicles.

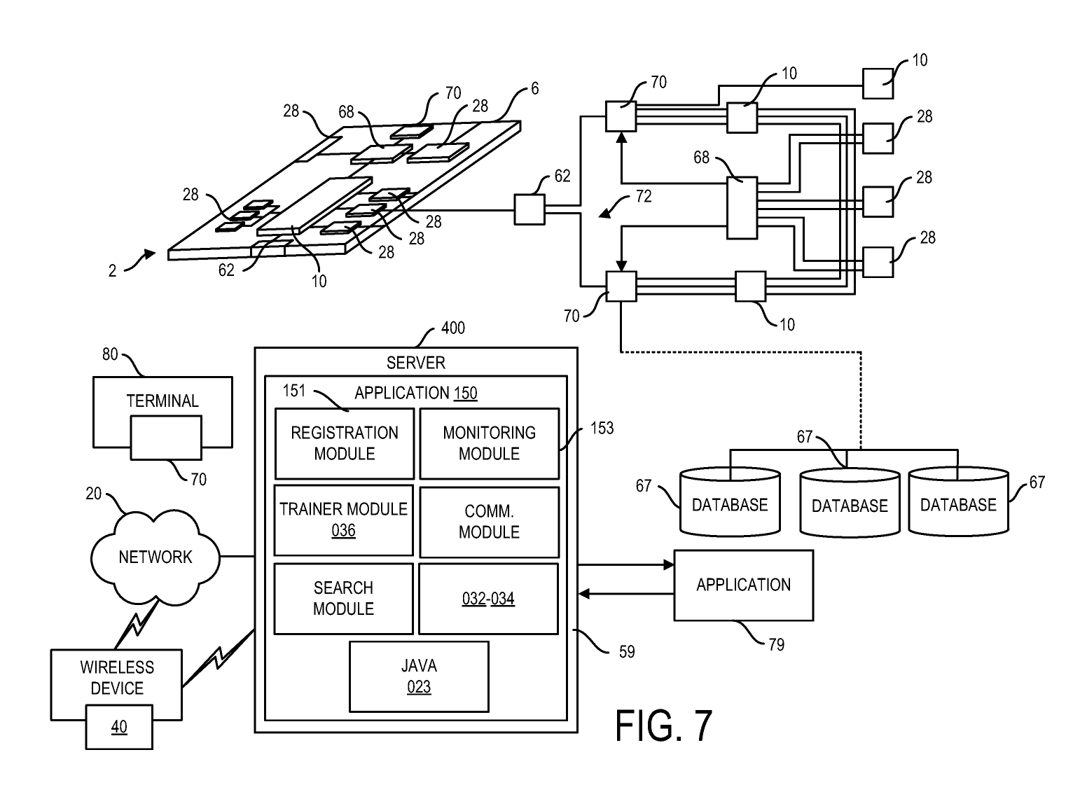

Referring to FIG. 7 is seen the biometric card 2 being disposed with the substrate 6. The substrate 6 is fused, etched or grooved to form a bond on the substrate and the nanofiber/microfiber material 5. The sweep-able biometric authentication sensor 10 may be affixed in the groove 11. The groove 11 is provided for guiding the finger 64 to direct pressure therein and for guiding the finger 64 to swipe across the sweep-able biometric authentication sensor 10 to enable rapid reading. Disclosed embodiments provide the biometric card 2 having a sweep-able biometric authentication sensor 10 further located in the low-stress region 62. Some embodiments provide the guiding groove 11 further provided for positioning the sweep-able biometric authentication sensor 10 around the strain region 4 for improving the sensing surface application and for guiding the finger 64 to sweep in a straight line direction as possible within the sensing surface region 28.

The biometric card 2, according to one embodiments of the present invention, provide the chip 68 further comprising CMOS multiple antennas on chip. The CMOS further includes MEMS-CMOS 90 comprising an RF device 100. The RF device 100 is connected to or embedded on the authentication platform 72. The authentication platform 72 further comprises an RF identification platform 102 in association with an RF reader/writer 74. The RF device 100 includes the multiple antennas on-chip 68, being disposed with software 48. The RF reader is further configured for communication with at least a server 500 being disposed for security application 150. The security application further includes registration via a registration module 151, monitoring via a monitoring module 153, training via a trainer module 036, searching via a search module 032 and 034, applying software rules and instructions 023 for the security application. The server 500 is further configured to provide computer security 20 and for communicating with a network, a remote terminal, a sticker 80, an RF device, a wireless device 40, an application module 79, and a database warehouse containing fingerprint data 67

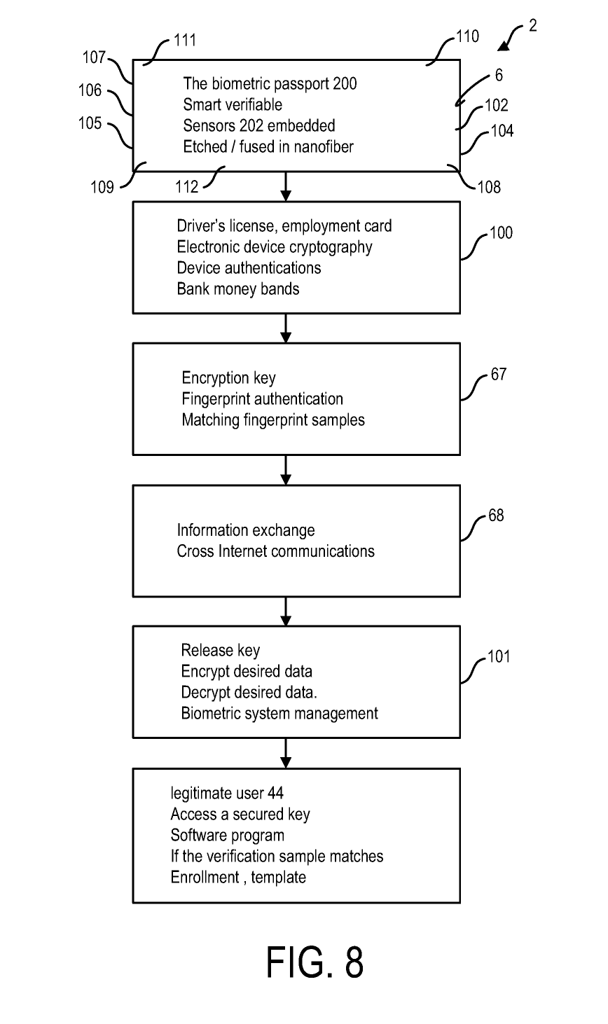

Referring to FIG. 8 is seen further application of the biometric card 2 in association with the RF device 100, according to certain embodiments of the present invention. The biometric card further includes a biometric passport 200 being disposed with sensors 202 embedded in substrate 6 and etched/fused in nanofiber to provide a smart verification application. The RE device 100 includes a CMOS multiple antennas chip 68. The RF device 100 is configured to allow electronic identification via the reading of data stored in the chip region further includes fingerprint data 67 for communication via the CMOS multiple antennas 68. The RF device 100 further includes FPGA substrate 101, thin film substrate 102, metamaterial substrate 103, CMOS substrate 104, MEMS substrate 105, photonic substrate 106, plasmonic substrate 107, electrochromic substrate 108, piezoelectric substrate 109, cantilever substrate 110, dielectric substrate 111, and NEMS substrate 112. Embodiment provide the substrate 6 further comprises an ideal high frequency capacitor region that have extremely high temperature stability and sharp self-resonance. Embodiments provide the substrate 6 comprising a high frequency device that is free from harmonic frequency and have extremely tight capacitance tolerance, low equivalent-series-resistance “ESR”, and low equivalent-series-inductance “ESL.” The high frequency device also has a zero voltage coefficient, and zero piezo noise further configured for enabling biometric authentication, internet security, data transport layer security, and data security.

The smart verification application further includes driver's license, employment card, electronic device cryptography, device authentication, and providing bank security via biometric/GPS embedded money bands. The multiple antennas on chip 68 is further configured to enable information exchange and to enable cross internet communication. Disclosed embodiments further provide the FPGA 101 further disposed with software for managing the biometric system, for releasing keys, for encrypting desired data, and for decrypting desired data. The software is further disposed for monitoring legitimate users, for accessing secured keys, and for verifying matched fingerprint samples via a template.

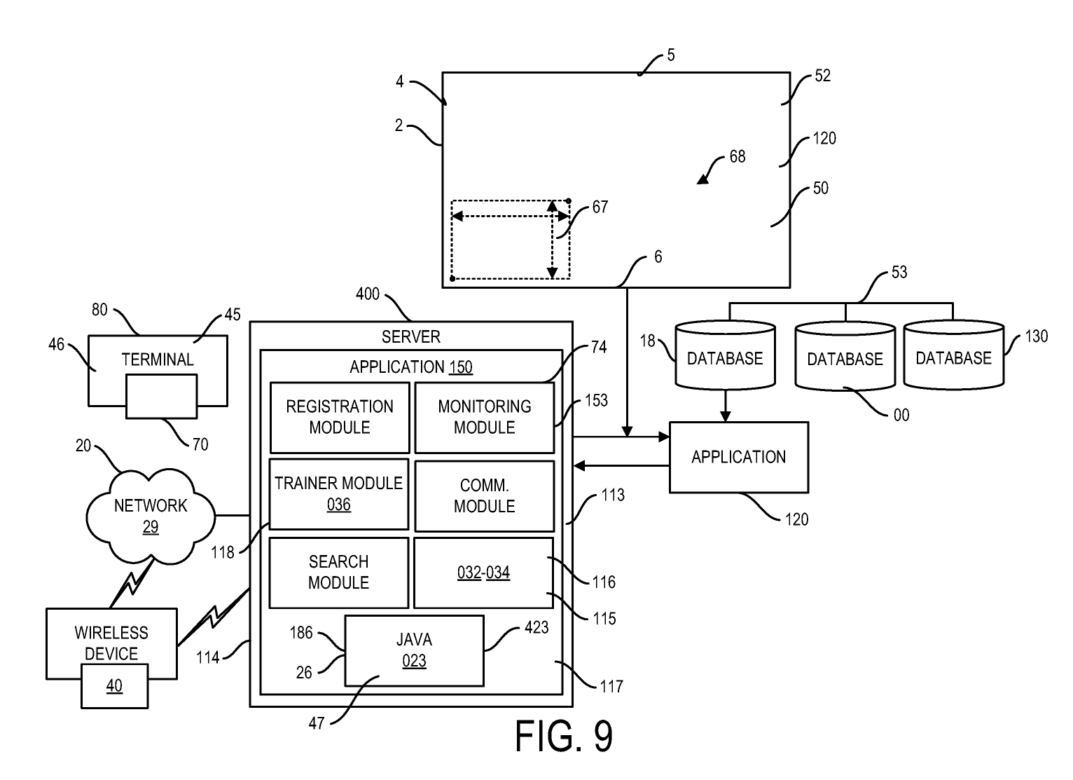

Referring to FIG. 9 is seen an illustration of the biometric card 2 comprising a passport in association with a CMOS antenna on substrate 68. The CMOS 68 further comprises a multiple frequency RF device 100, according to one embodiment of the invention. The RF device 100 further comprises a reader/writer 74 that includes at least a modulator 113 configured to receive baseband signals from CMOS multiple antennas on chip 68. The substrate 6 further comprises an energy device comprising an AC/DC converter 114 being provided and configured to receive alternating current (AC) and to convert the current back to direct current (DC). The substrate 6 further comprises an encoder 114. The encoder may include ultraviolet light source 115 and a magnetic reader 116, each configured for encoding information received to provide biometric data to be utilized by another device or protocol. Certain embodiments provide the substrate 6 comprising a decoder 117 configured to decode information from the encoder 114 to enable an output to be used by another device. The substrate is further etched/fused in nanofiber/microfiber material to provide communication clarity.

The substrate further comprising at least one of nanofiber substrate, microfiber substrate, piezoelectric substrate, carbon black substrate, load cell substrate, MEMS substrate, NEMS substrate, thin film substrate, cantilever substrate, carbon nanotubes substrate, FPGA substrate, opto-isolator substrate, plasmonic substrate, photonic substrate, electrochromic substrate, zinc substrate, non-ferrous substrate, herein referred to as the substrate 6, which are deployed with embedded sensors 24 and nanofibers 12 having excellent conductive properties. The substrate is configured to provide communication applications, faster data transmission, and stronger signal strength for network applications.

The energy from the substrate 6 is controlled by a miniaturized power control 118 configured to regulate voltage and also to regulate current to protect against power surges or against low power application. The software 48 includes a software program configured to instruct a sequencer 118 to queue instructions to the internal memory of the chip region associated with the fingerprint data 67. Embodiments further provide the biometric card 2 and the reader/writer 74 comprising a biometric system management application “BSMA” 120 configured with sets of instructions, rules and codes to check and validates cryptographic keys as a means for biometric authentication. The biometric authentication includes cryptographic security applications in association with the biometric system management application for storing security keys so that they may be checked or be validated to grant or deny access to the database or memory chip. Embodiments further provide an EEPROM 118 comprising an erasable programmable memory configured to stores data so that information may be programmed, read and/or written.

Disclose embodiments provide the biometric card 2 further configured for communication via a remote terminal such as a tablet 45, a cell phone 46, and a personal digital assistant (PDA) 47. The biometric card 2 further comprises a passport, a driver's license, an employment card, electronic device cryptography, device authentications, bank money bands, and a medical card. The present invention can be used for vehicle identification, border crossing solutions, identification of traffic violations, insurance programs applications, vehicle access control, toll booths, and other vehicle control applications, an insurance card, a bank card, a medical insurance card, credit card, airport boarding pass, passport, a door entry card, and an RF identification mechanism. In one embodiment, the present invention can incorporate at least one of nanofiber/microfiber Material embedded sensors configured for identifying security features. This material has good electrical characteristics and may include metalized polyester treated to prevent auto adhesive hologram from being transferred from one document to another.

The present invention further provides the application of biometrics card 2 that includes DNA fingerprinting 50 and programmed phone numbers 52 to overcome cryptographic deficiencies and other hologram difficulties and color-grain duplications. The biometric card 2 will also eliminate the application of security codes in key security applications. The CMOS multiple antenna on chip 68 is a highly secured chip with a programmable cryptographic cell for exchanging the card number such as passport number, driver's license number or credit card number with the phone number 52, which is written into the chip for allowing communications depending on the exchange key for the biometric card 2. Embodiment provide the DNA fingerprinting 50 as another method of enabling the exchange keys relating to the individual information of a person or for identifying a vehicle information that includes biometrics contained in the memory of a computer or remote device 53. The remote device 53 further comprises a database warehouse, server 400 for a centralized database security system that is configured to centrally communicate with the database warehouse.

Embodiments further provide the biometric card 2 configured to enable first Level Security Features. Disclosed embodiment provide the first-level security features include a complex biometric card numbers 00 with multiple security features, combining a complex card number structure with programmed phone number 52 for auto dialing. The biometric card number 00 and the phone number 52 are transferred via a registration and authentication sensor to assure a very high security accuracy. In one embodiment of the present invention, the biometric card number 00 includes many general features. The biometric card number 00 is further configured to makes object visibly distinguished with the programmed phone number 52 and nanofiber materials 5. The biometric card number 00 is configured to ensure more satisfying security features than conventional card number methods.

Disclosed embodiment further provide the biometric card 2 as an RF Device that is configured to complement biometric security features and to associate the information contained on it with other database information in line with other cryptographic methods. The biometric card 2 further includes a memory to allow information about the user to be stored on the device such as biometric authentication processes or biographical information and/or usable statistical information. The RF device 100 allows data to be written to and read from the device via the CMOS multiple antennas on chip 68. The biometric card 2 would not need to be presented for verification through traditional methods such as visual inspection, or other method of machine reading since all data collected are transmitted directly to the reader/writer 74, and information about the biometric card 2 rightful owner is also contained within the reader 74. The biometric card 2 association with the reader 74 makes the DNA fingerprinting authentic because the fingerprint is associated with the card owner and all other information about the owner are readily verifiable.

Disclosed embodiments further provide the biometric card comprising a biometric identification information system that includes embedded biometric template, social security number, photography, employee identification number, driver's license number, medical number, health insurance number, patients number, flight number, phone number, passport number, cell number, criminal identification number, house arrest number, that may be collected and written to the chip for RF communications whereby the RF reader/writer 74 is configured to read the identification information for authentication, data security, internet security, data transport layer security, and for enabling data confirmation.

The RF reader is further configured for communication with the server 400. The server is disposed for security application 150. The security application further includes registration via a registration module 151, monitoring via a monitoring module 153, training via a trainer module 036, searching via a search module 032 and 034, applying software rules and instructions 023 for the security application. The server 400 is further configured to provide computer security 20, biometric data content application 130, and for communicating with a network 29, a remote terminal, a sticker 80, an RF device 70, BSMA 120, employee data authentication 186, banks data authentication 423, BAS 25, a wireless device 40, an application module 79, and a database warehouse containing fingerprint data 67

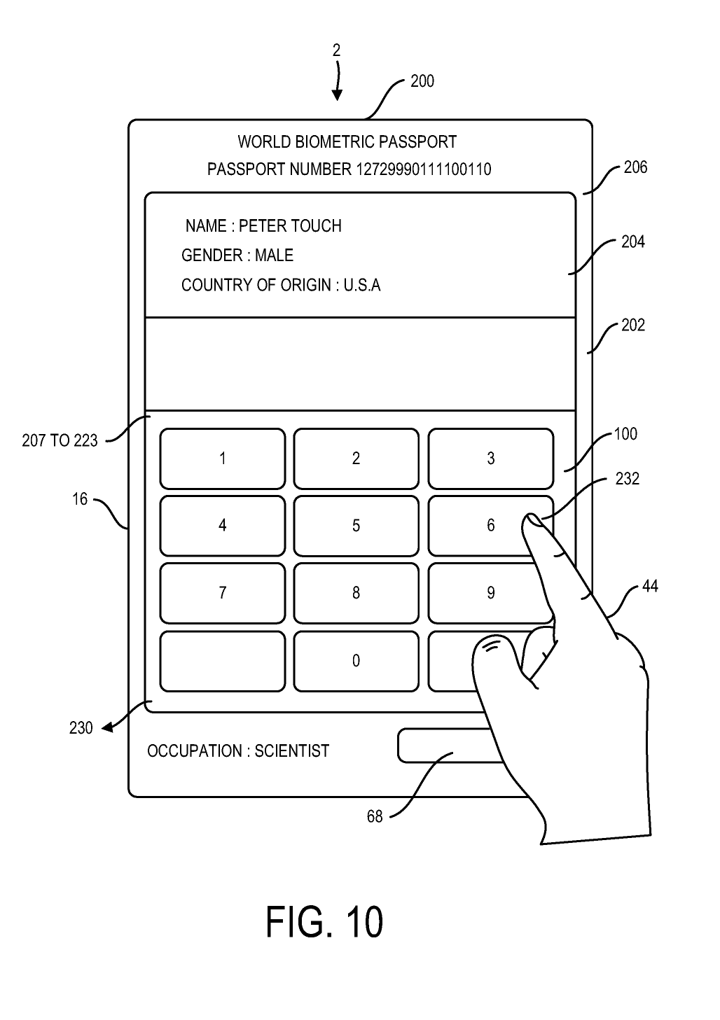

Referring to FIG. 10 is seen an illustration of the biometric card 2. Certain embodiments provide the biometric card 2 comprising a biometric passport 200. The passport 200 is disposed with sensors 202 embedded in substrate 204 and etched/fused in nanofiber/microfiber material 206. The substrate 204 further comprises CMOS substrate 207, cantilever substrate 208, MEMS substrate 209, FFGA substrate 210, thin film substrate 211, photonic substrate 212, plasmonic substrate 213, die-electric substrate 214, piezoelectric substrate 215, carbon char substrate 216, ceramic substrate 217, nanofiber substrate 218, microfiber substrate 219, nanowire substrate 220 metamaterial substrate 221, MEMS substrate 222, NEMS substrate 223, each comprises a substrate and may be embedded into the biometric card such as the passport. The chip 68 is embedded into the passport 200 to provide a document method in record for all travel destinations. The chip 68, is configured for communication with the passport 200 to enable location awareness and also to enable efficient passport identification method. The passport identification method includes retrieving information that is to be matched to the identity of the person who owns the passport.

Some embodiments provide the passport 200 to be first initialized. Other embodiments provide the passport 200 embedded with personal information and/or biometrics that are encoded on the passport for communications with the RF device 100. The encoding may be done after the passport 200 is personalized for security reasons. The passport 200 is a biometric passport that would be of no utility if stolen because the thief would need to be initialized with proper biometric encryption keys and personalized keys as embodied herein. The passport biometric encryption Key “PEEK” is configured to securely binds other digital keys such as social security, date of bird, phone number, credit card number, passport number, driver's license number, bank card number, to biometric method to generate a digital key from the biometrics so that the key will be recreated only if the genuine biometric sample is presented for verification purposes. Certain embodiments provide the output of the passport biometric encryption key “PBEK” authentication method is configured to produce either a key or a failure message.

Disclosed embodiments further provide a biometric card 2 comprising portable apparatus for measuring biological characteristics influential to trait recognition and/or fraud. Certain embodiment provides the biometric card 2 further configured for verifying the identity of a human being. Some embodiments provide the biometric card 2 further configured for analyzing biological characteristics such as human characteristics for security and identification purposes. The analysis includes at least fingerprint, hand, eye, face, and voice. Other embodiments provide the biometric card 2 further comprises means for identifying biological characteristics to detect from a database of fingerprints, a known criminal by matching fingerprint samples collected against the prints in the criminal database.

The invention further relates to a biometric card 2 in association with a database 230 of collected DNA samples having accurate and distinctive fingerprint classification schemes or pattern that is required for expediting fingerprinting processes. Disclosed embodiments further provide the biometric card 2 configured for communication with the database 230 for reducing the required database search to identify characteristics of the hand, finger, face, voice, ear shape, DNA, body odor, or eye. The identification process for the biometric card 2 further includes biometric identification and authentication. Disclosed embodiments provide the biometric card 2 being disposed to eliminate trait by enabling biometric identification as a process of matching an individual to a set of biometric characteristics within a system such as the database 230. The database 230 is configured with software instructions 232 that includes rules for enabling biometric authentication. Certain embodiment provides the rules include a one-to-one match for verifying that the individual who presents the biometric card 2 is who he claims to be or the person entering a building or accessing an electronic system such as the logon to a computer system is who he says he is by identifying the biometrics such as DNA fingerprints and sweat pore location.

Some embodiments provide the biometric card 2 further configured for providing an excellent cryptographic environment to ensure secured information exchange across the Internet 16 to enable cross Internet communications “CIC.” Other embodiments provide the biometric card 2 further configured for providing computer security across information exchange environments such as the Internet and social media platforms because current computer security requires computer users to remember and enter their cryptographic keys each time they want to use the computer. Because of the current cryptographic deficiencies, users typically are required to choose an easily remembered passcode that is used to encrypt the cryptographic key. This encrypted key is then stored on a computer's hard drive. To retrieve the cryptographic key, the user is prompted to enter the passcode, which will then be used to decrypt the key.

The present invention is presented to eliminate the insecurity of the cryptographic key, including the conventional passcode system due to practical problems of remembering various passcodes. Additionally, some users tend to choose simple words, phrases, or easily remembered personal data, while others resort to writing the passcode down on an accessible document to avoid data loss. The ongoing deficient passcode methods of security poses potential security risks because the passcode is not tied to a user directly. That is, the system running the cryptographic algorithm is unable to differentiate between the legitimate user 44 and an attacker who fraudulently acquires the passcode of a legitimate user 44. Disclosed embodiments provide the biometric card 2 are an alternative to passcode protection because the biometric authentication offers a new platform/mechanism for key security applications by using a biometric to secure the cryptographic key. That is, instead of entering a passcode to access the Cryptographic key, disclosed embodiments provide the biometric card 2 as an advanced system so that the use of this key is guarded by biometric authentication. In this endeavor, when a computer user wishes to access a secured key, the software program will prompt the user to allow the capture of a biometric sample. If this verification sample matches the enrollment template, then the key is released and can be used to encrypt or decrypt the desired data. Disclosed embodiments provide the biometric card 2 as a means to offer convenience because the user 44 will no longer need to remember the passcode or to secure identity confirmation because only the valid user can use the biometric card 2.

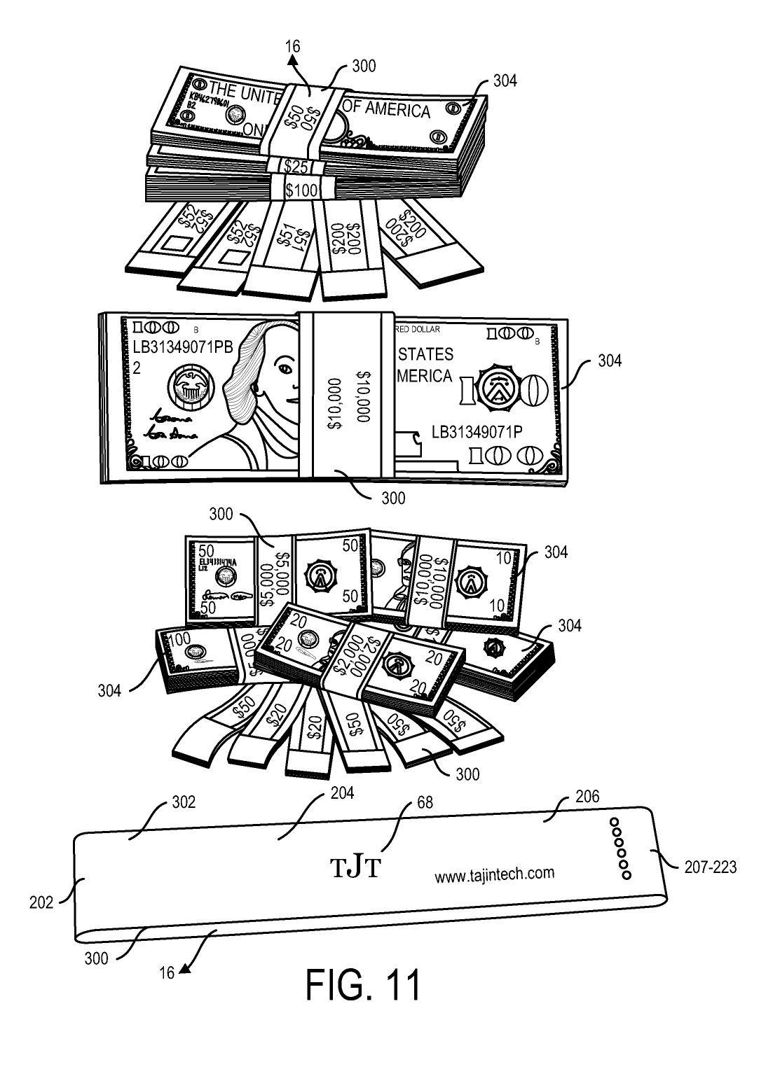

Referring to FIG. 11 is seen an exemplary embodiment of the biometric application. The biometric application includes a money band 300, being disposed with substrate 207-223. Sensors 202 are embedded in the substrate and etched/fused in nanofiber material 206, and a miniaturized CMOS multiple antennas on chip 68 are disposed with software for enabling internet communications. At least a global positioning sensor “GPS” 302 is disposed with the substrate. The band is to be used for monetary application, such that when a bank is robbed, the GPS and the multiple antennas would enable communications with law enforcement authorities so that the actual location of the money would be identified and the fingerprints of the robbers would be Located.

While certain aspects and embodiments of the disclosure have been described, these have been presented by way of example only, and are not intended to limit the scope of the disclosure. Indeed, the novelty of the biometric card 2 described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed is:

1. A biometric card; comprising: a substrate; a sensor; multiple antennas on chip; an electronic device; and nano fibers.

2. The biometric card according to claim 1, wherein said sensor further configured with said substrate to provide at least one of a biometric authentication sensing surface; communication applications; network applications; detection applications.

3. The biometric card according to claim 1, wherein said sensor further comprises at least one of nano-sensor; pressure sensor, said sensor disposed with the substrate to provide at least one of fingerprint authentication; biometric input; biometric data; faster data transmission; and a cell platform.

4. The biometric card according to claim 1, wherein said substrate further comprises the biometric authentication sensing surface further configured to collect biometric data of a person.

5. The biometric card according to claim 1, wherein said sensor further embedded in said substrate for detection; communication and for network applications and services.

6. The biometric card according to claim 1, wherein said nanofiber further fused/etched in said substrate to provide a sensing surface and to enable communications; detections, faster data transmissions, and network services.

7. The biometric card according to claim 1, wherein said chip is disposed with software.

8. The biometric card according to claim 1, wherein said multiple antennas on chip further comprises multiple frequency antennas in communication with said electronic device.

9. The biometric card according to claim 1, wherein said electronic device further comprises devices for online applications, devices for mobile applications, comprising at least one of computer apparatus; communication apparatus; and network apparatus.

10. The biometric card according to claim 1, wherein said electronic device further comprises a reader, a mobile application, a cell phone, a passport, an identification card, a mobile application software, configured for communication with said sensor to authenticate biometric data.

11. The biometric card according to claim 1, wherein said multiple antennas on chip further configured for communications with at least one of biometric card, electronic device; network and mobile application processors.

12. The biometric card according to claim 2, wherein said biometric authentication sensing surface further configured for biometric encryption.

13. The biometric card according to claim 1, wherein said sensor further embedded in said substrate for measuring biological characteristics and for associating a person's DNA with rights.

14. The biometric card according to claim 1, wherein said sensor further embedded in said substrate and associated with said multiple antennas on chip for communication with said electronic device to identify biological characteristics.

15. The biometric card according to claim 1, wherein said electronic device further configured for at least one of analyzing biological characteristics, downloading a mobile application, enabling biometric authentication for online transactions via said mobile application, communicating with said sensor.

16. The biometric card according to claim 1, wherein said multiple antennas on chip in communication with said electronic device to provide at least one of detect trait; communicate with a database; communicate with a mobile application software, collect DNA samples; match DNA samples; authenticate devices; enable device cryptography; recognize fraud; communicate with remote electronic devices; enable network communications; enable biometric authentication for online transactions; enable biometric encryption key; provide cross internet communications.

17. The biometric card according to claim 1, wherein said electronic device further comprises a mobile device configured for mobile applications, including remote biometric input and for receiving biometric data via at least one of Internet communications; short range communication via radio frequency antennas.

18. The biometric card according to claim 1, wherein said substrate further comprises a composite material, the composite material includes a conductive layer embedded in a flexible region for connecting said sensor to at least a pressure point, further comprises means for collecting biometric information for remotely identifying an individual associated with a transaction information.

19. The biometric card according to claim 18, wherein said transaction information further comprises at least one of online purchases; purchases; boarding pass; passport processing; driver's license; medical card; insurance card; employee identification; computer encryption key; code entry environment; an environment for personal identification; bank money bands application, credit card applications; accessing security key; verification environment, end-to-end processing; end-to-end receiving; computer login; passport information; credit card information; bank account information; electronic device access keys; mobile application software for remote biometric authentication; and access points.

20. The biometric card according to claim 1, wherein said electronic device further comprises a mobile device, the mobile device further comprises a passport; a cellphone, a bank card; a driver's license; an insurance card; a health insurance card; a medical card; an employee card; a boarding pass; a Wi-Fi; a Li-Fi; a money band; a mobile biometric processor; credit card; wireless device; cell phone, an electronic biometric processing device; a portable device; a wearable device; Internet enable device; or tablet.
